(19) United States
(12) Patent Application Publication
(10) Pub. No.: US 2026/0001433 A1
(43) Pub. Date: Jan. 1, 2026

(54) METHOD, APPARATUS, AND SYSTEM OF PROVIDING ELECTRICAL VEHICLE CHARGING STATION AVAILABILITY

(71) Applicant: HERE Global B.V., Eindhoven (NL)

(72) Inventors: Stefano BENNATI, Zürich (CH); Johannes BRAESE, Berlin (DE)

(21) Appl. No.: 18/758,781

(22) Filed: Jun. 28, 2024

(51) Int. Cl. B60L 53/65; B60L 53/66; G06Q 10/02

(52) U.S. Cl. CPC B60L 53/65; B60L 53/665; G06Q 10/02; B60L 2240/62; B60L 2240/70

(57) ABSTRACT

An approach is provided for electric vehicle charging station availability. The approach involves, for example, receiving transmissions from one or more vehicles. Each transmission comprises a list of charging stations, estimated times of arrival for the one or more vehicles to reach each charging station, and values computed to indicate a preference of the one or more vehicles to reach each charging station. The approach also involves processing the list of the one or more charging stations, estimated times of arrival, and preference values to determine respective probabilities that each charging station will be available at the estimated times of arrival. The approach further involves determining at least one recommended charging station from among the charging stations based on the respective probabilities.

### BACKGROUND

Electric vehicles (EVs) are becoming more popular as an alternative to combustion engine vehicles, due to their environmental and economic benefits. However, EVs have some drawbacks, such as lower range and longer recharging time, that require careful trip planning. Trip planning for EVs involves finding optimal charging locations and durations, to ensure that the vehicle can reach the destination and minimize the waiting time. EV charging optimization algorithms are developed to assist drivers with this task, by suggesting where to charge and for how long, based on the vehicle's battery level, the distance to the destination, and the availability of charging stations. However, providing real-time availability information of EV charging stations poses significant technical challenges for map service providers, especially when the privacy of drivers requesting such information are to be preserved.

### SOME EXAMPLE EMBODIMENTS

Therefore, there is a need for an approach for providing electric vehicle (EV) charging station availability.

According to one embodiment, a method comprises receiving one or more transmissions from one or more vehicles. Each of the one or more transmissions comprises a list of one or more charging stations, one or more estimated times of arrival for the one or more vehicles to reach each of the one or more charging stations, and one or more preference values computed to indicate a preference of the one or more vehicles to reach each of the one or more charging stations. The method also comprises processing the list of the one or more charging stations, the one or more estimated times of arrival, and the one or more preference values to determine respective probabilities that each of the one or more charging stations will be available at the one or more estimated times of arrival. The method further comprises determining at least one recommended charging station from among the one or more charging stations based on the respective probabilities. The method further comprises providing the at least one recommended charging station as an output.

Embodiments described herein include a computer program product having computer-executable program code portions stored therein, the computer-executable program code portions including program code instructions configured to perform any method disclosed herein.

According to another embodiment, an apparatus comprises at least one processor, and at least one memory including computer program code for one or more computer programs, the at least one memory and the computer program code configured to, with the at least one processor, cause, at least in part, the apparatus to receive one or more transmissions from one or more vehicles. Each of the one or more transmissions comprises a list of one or more charging stations, one or more estimated times of arrival for the one or more vehicles to reach each of the one or more charging stations, and one or more preference values computed to indicate a preference of the one or more vehicles to reach each of the one or more charging stations. The apparatus is also caused to process the list of the one or more charging stations, the one or more estimated times of arrival, and the one or more preference values to determine respective probabilities that each of the one or more charging stations will be available at the one or more estimated times of arrival. The apparatus is further caused to determine at least one recommended charging station from among the one or more charging stations based on the respective probabilities. The apparatus is further caused to provide the at least one recommended charging station as an output.

According to another embodiment, a non-transitory computer-readable storage medium carries one or more sequences of one or more instructions which, when executed by one or more processors, cause, at least in part, an apparatus to receive one or more transmissions from one or more vehicles. Each of the one or more transmissions comprises a list of one or more charging stations, one or more estimated times of arrival for the one or more vehicles to reach each of the one or more charging stations, and one or more preference values computed to indicate a preference of the one or more vehicles to reach each of the one or more charging stations. The apparatus is also caused to process the list of the one or more charging stations, the one or more estimated times of arrival, and the one or more preference values to determine respective probabilities that each of the one or more charging stations will be available at the one or more estimated times of arrival. The apparatus is further caused to determine at least one recommended charging station from among the one or more charging stations based on the respective probabilities. The apparatus is further caused to provide the at least one recommended charging station as an output.

According to another embodiment, an apparatus comprises means for receiving one or more transmissions from one or more vehicles. Each of the one or more transmissions comprises a list of one or more charging stations, one or more estimated times of arrival for the one or more vehicles to reach each of the one or more charging stations, and one or more preference values computed to indicate a preference of the one or more vehicles to reach each of the one or more charging stations. The apparatus also comprises means for processing the list of the one or more charging stations, the one or more estimated times of arrival, and the one or more preference values to determine respective probabilities that each of the one or more charging stations will be available at the one or more estimated times of arrival. The apparatus further comprises means for determining at least one recommended charging station from among the one or more charging stations based on the respective probabilities. The apparatus further comprises means for providing the at least one recommended charging station as an output.

According to one embodiment, a method comprises identifying one or more charging stations that are within a range of a vehicle based on a battery level of the vehicle. The method also comprises determining one or more estimated times of arrival for the vehicle to reach each of the one or more charging stations. The method further comprises determining one or more preference values computed to indicate a preference of the vehicle to reach each of the one or more charging stations. The method further comprises sending a transmission comprising a list of the one or more charging stations, the one or more estimated times of arrival, and the one or more preference values. The one or more charging stations, the one or more estimated times of arrival, and the one or more preference values are used to determine respective probabilities that each of the one or more charging stations will be available at the one or more estimated times of arrival.

According to another embodiment, an apparatus comprises at least one processor, and at least one memory including computer program code for one or more computer programs, the at least one memory and the computer program code configured to, with the at least one processor, cause, at least in part, the apparatus to identify one or more charging stations that are within a range of a vehicle based on a battery level of the vehicle. The apparatus is also caused to determine one or more estimated times of arrival for the vehicle to reach each of the one or more charging stations. The apparatus is further caused to determine one or more preference values computed to indicate a preference of the vehicle to reach each of the one or more charging stations. The apparatus is further caused to send a transmission comprising a list of the one or more charging stations, the one or more estimated times of arrival, and the one or more preference values. The one or more charging stations, the one or more estimated times of arrival, and the one or more preference values are used to determine respective probabilities that each of the one or more charging stations will be available at the one or more estimated times of arrival.

According to another embodiment, a non-transitory computer-readable storage medium carries one or more sequences of one or more instructions which, when executed by one or more processors, cause, at least in part, an apparatus to identify one or more charging stations that are within a range of a vehicle based on a battery level of the vehicle. The apparatus is also caused to determine one or more estimated times of arrival for the vehicle to reach each of the one or more charging stations. The apparatus is further caused to determine one or more preference values computed to indicate a preference of the vehicle to reach each of the one or more charging stations. The apparatus is further caused to send a transmission comprising a list of the one or more charging stations, the one or more estimated times of arrival, and the one or more preference values. The one or more charging stations, the one or more estimated times of arrival, and the one or more preference values are used to determine respective probabilities that each of the one or more charging stations will be available at the one or more estimated times of arrival.

According to another embodiment, an apparatus comprises means for identifying one or more charging stations that are within a range of a vehicle based on a battery level of the vehicle. The apparatus also comprises means for determining one or more estimated times of arrival for the vehicle to reach each of the one or more charging stations. The apparatus further comprises means for determining one or more preference values computed to indicate a preference of the vehicle to reach each of the one or more charging stations. The apparatus further comprises means for sending a transmission comprising a list of the one or more charging stations, the one or more estimated times of arrival, and the one or more preference values. The one or more charging stations, the one or more estimated times of arrival, and the one or more preference values are used to determine respective probabilities that each of the one or more charging stations will be available at the one or more estimated times of arrival.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

For various example embodiments, the following is applicable: methods described herein may be computer-implemented methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing electric vehicle (EV) charging station availability, according to one example embodiment;

FIG. 2 is a diagram illustrating a vehicle charging platform or module, according to one example embodiment;

FIG. 3 is a flowchart of a process for providing EV charging station availability from an on-vehicle perspective, according to one example embodiment;

FIG. 4 is a diagram of a data format for transmitting EV charging information, according to example embodiment;

FIG. 5 is a flowchart of a process for providing EV charging station availability from a charging infrastructure perspective, according to one example embodiment;

FIG. 6 is a diagram of an example user interface for setting preferences for generating EV charging station updates, according to one example embodiment;

FIG. 7 is a diagram of an example user interface for providing EV charging station availability, according to one example embodiment;

FIG. 8 is a diagram of a geographic database, according to one example embodiment;

FIG. 9 is a diagram of hardware that can be used to implement an example embodiment;

FIG. 10 is a diagram of a chip set that can be used to implement an example embodiment; and

FIG. 11 is a diagram of a mobile terminal (e.g., client terminal, vehicle, or part thereof) that can be used to implement an example embodiment.

### DESCRIPTION OF SOME EMBODIMENTS

Examples of a method, apparatus, and computer program for providing electric vehicle (EV) charging station availability are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

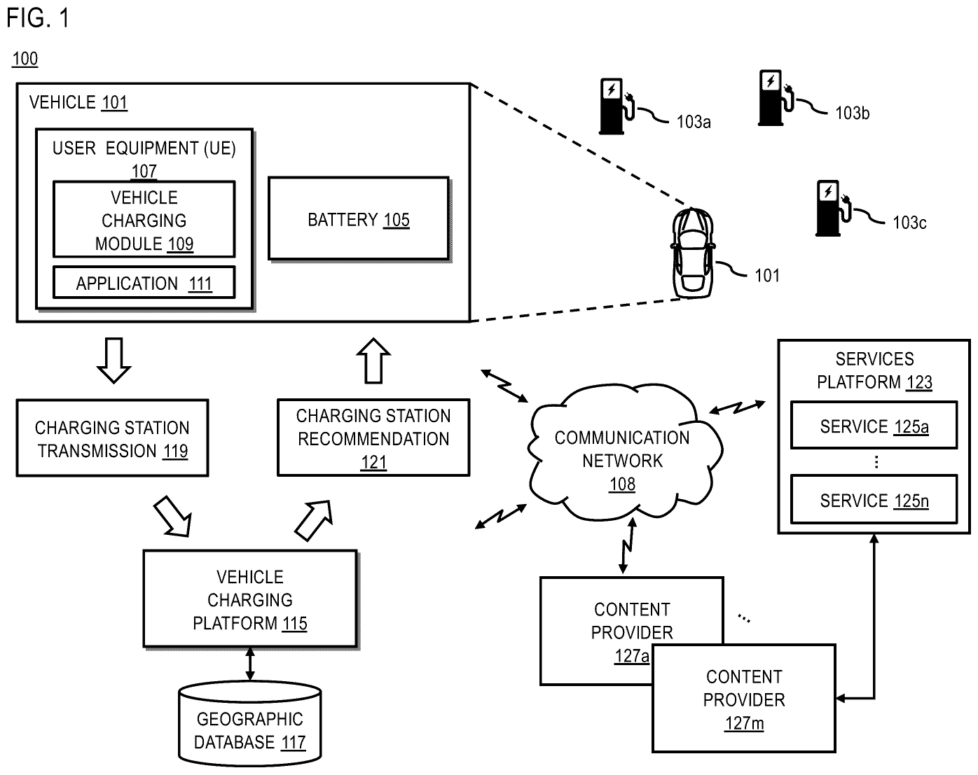

FIG. 1 is a diagram of a system capable of providing electric vehicle (EV) charging station availability, according to one example embodiment. EVs (e.g., vehicle 101) are becoming increasingly popular as an environmentally friendly and cost-effective alternative to conventional vehicles powered by fossil fuels. An EV is a vehicle (e.g., vehicle 101) that uses one or more electric motors for propulsion. Unlike conventional vehicles that run on gasoline or diesel, EVs rely on electricity as their source of energy. EVs can be charged from external sources, such as public or private charging stations (e.g., charging stations 103a-103c, also collectively referred to as charging stations 103), or from self-contained sources, such as solar panels or batteries. EVs offer several advantages over conventional vehicles, such as lower emissions, higher efficiency, and lower operating costs.

However, EVs also face some challenges, such as limited range and dependence on the availability and accessibility of charging infrastructure. Accordingly, one of the main challenges that EV drivers face is finding a suitable and available charging station 103 to recharge their batteries (e.g., battery 105) along their routes. Unlike conventional vehicles, which can refuel at any gas station within minutes, EVs need to locate a compatible charging station 103, plug in their vehicle 101, and wait for a sufficient amount of time to replenish their battery level. This poses a significant inconvenience and uncertainty for EV drivers, especially when they travel long distances or encounter high demand for charging slots. For example, EV charging generally requires the vehicle 101 to occupy the charging outlet of a charging station 103 for a long time, therefore the few available charging outlets can become a bottleneck that can cause long waiting times.

To mitigate this issue, various EV charging optimization algorithms have been proposed to assist EV drivers in planning their trips and finding optimal charging stations. These algorithms aim to minimize the total travel time, which includes both driving time and charging time, as well as the waiting time at the charging stations. To achieve this goal, the algorithms need to predict the availability of charging stations at future times, based on the current and expected behavior of other EVs in the area. However, such predictions traditionally require access to potentially private data about the vehicles, such as their current route, charge state, destination, and vehicle capabilities. For example, traditional charging optimization algorithms require significant amounts of information about a majority of EVs such as but not limited to:
The current and expected charge rate at arrival of all vehicles;
The current and expected traffic conditions;
The route of all vehicles; and
The destination of all vehicles.

This information is sensitive and introduces privacy risks as well as places a significant load on compute resources such as bandwidth to transmit the information and compute/memory resources to process and store the information. Traditional algorithms then combine this information with data from charging points, e.g., busy/free status, to convert the information into predictions about whether a charging station 103 will be available at a given point in the future.

Anonymization can be used to protect privacy, but traditional anonymization algorithms are not suitable for this use case as they break vehicle trajectories in subsections, which obfuscate the route that a vehicle 101 takes. Additionally, adding to such anonymized data, information such as battery level or other states/characteristics of the vehicle 101 could weaken the anonymization and enable easier re-identification of vehicles 101 and/or drivers. For example, this is because the battery level can be used to identify which subsections correspond to the same trajectories, by estimating how much the battery charge would have decreased and comparing this value with battery charge levels of other subsections.

Therefore, there is a need for a method, apparatus, and system of providing EV charging station availability information to EV drivers, without compromising their privacy and of reducing the compute resources and bandwidth required to collect and process this privacy sensitive information particularly as the number of EVs providing such data increases.

To address these technical challenges, the system 100 introduces a capability that enables each vehicle 101 (e.g., an EV) to compute predictions about EV charging station availability, without revealing private information about the drivers of EVs, e.g., routes. Instead of sharing routing and position information with a service provider for the provision of recommendations and optimization, each EV computes probabilities and/or provide information for computing the probabilities (e.g., list of nearby charging stations 103 with ETAs, preference for each charging station 103, and/or required charging time) of reaching different charging points 103 and exchanges those (e.g., over a communication network 108). In one embodiment, the system 100 uses asymmetrical handling of information on vehicle and in the charging infrastructure, such that the two different processes synergistically collaborate towards providing EV charging without exchange of sensitive data while also advantageously reducing the amount of information that is exchange thereby reducing associated bandwidth and compute/memory resource requirements. In one embodiment, the on-vehicle processes are handled via a vehicle charging module 109 and/or equivalent application 111 executing on a user equipment (UE) 113 (equivalent component of the vehicle 101). In one embodiment, the charging infrastructure processes are handled via a vehicle charging platform 115 (e.g., a server or cloud component of the system 100) or can also be handled locally via the vehicle charging module 109.

As shown in FIG. 1, the vehicle charging module 109 can identify candidate charging stations 103 (e.g., charging stations 103 within a threshold proximity of the vehicle 101, its route, its destination, etc.) based on map data of a geographic database 117, and then determine the probabilities or information for determining the probabilities of reaching one or more of the charging stations 103. These probabilities and/or information can be sent as one or more charging station transmissions 119 to the vehicle charging platform 115. In one embodiment, the vehicle charging platform 115 can aggregate the charging station transmissions 119 from one or more vehicles 101 compute the availability of each charging station at future times, without knowing the identity or location of the EVs. The algorithm enables the service provider to offer recommendations (e.g., charging station recommendations 121) and optimization services to the EV drivers, based on the availability information and the preferences of the drivers.

In one embodiment, the charging station availability information can also be used to automatically provide one or more services (e.g., available via a services platform 123 comprising services 125a-125n, also collectively referred to as services 125). Example of such services 125 include EV charging services whereby, the vehicle charging platform 115 can automatically reserve slots (e.g., via service application programming interfaces (APIs) or equivalent) at available or recommended charging stations 103 for a vehicle 101. The system 100 further comprises one or more content providers 127a-127m (also collectively referred to as content providers 127) to provide information or data (e.g., charging station locations, charger types, compatibility information, etc.) for performing the various embodiment described herein.

As noted, the various embodiments described herein can run both on the device (at the edge, in real time via, e.g., the vehicle charging module 109) and/or on the backend (e.g., via the vehicle charging platform 115), and requires lower bandwidth and compute resources in comparison to traditional methods that transmit all trajectory data to the service provider to determine charging station availability. In addition, by removing the need to share battery levels, anonymization of this data for other purposes, e.g., traffic estimation, becomes possible with traditional anonymization algorithms and therefore adds to the value of data. Moreover, no private information is sent outside of the vehicle, particularly in embodiments in which, the probabilities of the vehicle 101 reaching a charging station 103 is determined on vehicle and only the probabilities are exchanged.

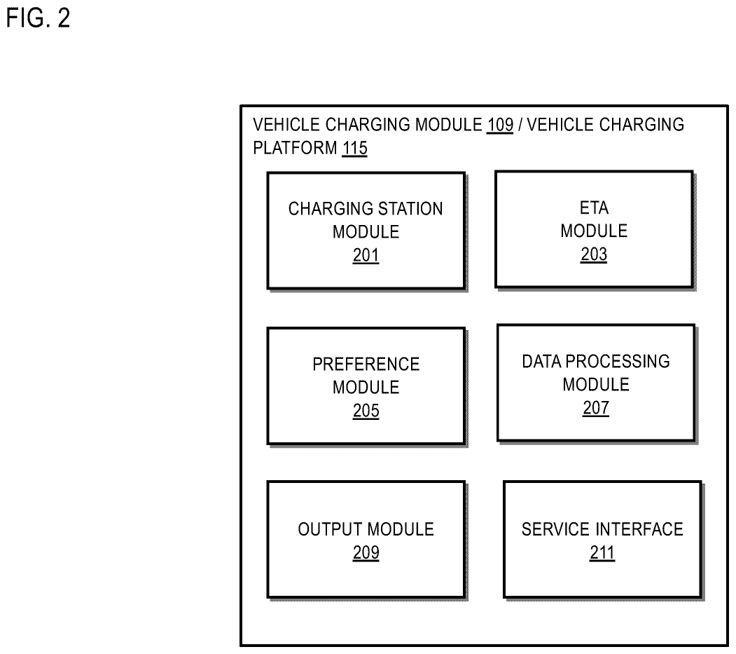

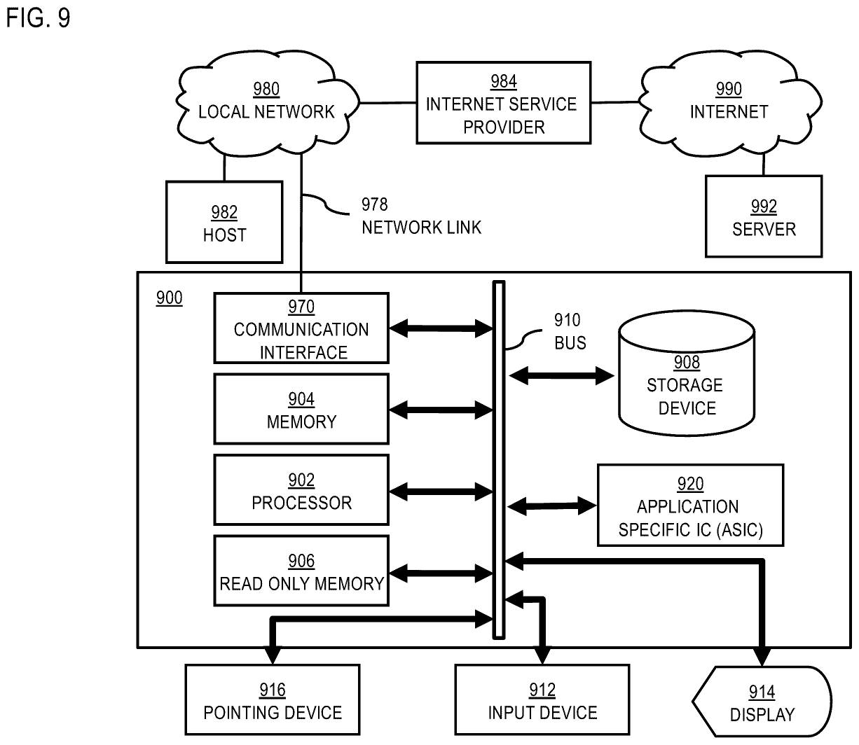

FIG. 2 is a diagram illustrating a vehicle charging platform 115 or module 109, according to one embodiment. By way of example, the vehicle charging module 109 and/or vehicle charging platform 115 include one or more components for performing the various embodiments described herein alone or in combination. It is contemplated that the functions of these components may be combined or performed by other components of equivalent functionality. In one embodiment, the vehicle charging module 109 and/or vehicle charging platform 115 include a charging station module 201, ETA module 203, preference module 205, data processing module 207, output module 209, and service interface 211. The above presented modules and components of the vehicle charging module 109 and/or vehicle charging platform 115 can be implemented in hardware, firmware, software, circuitry, or a combination thereof such as but not limited to the hardware illustrated in FIGS. 9-11. It is contemplated that the vehicle charging module 109 and/or vehicle charging platform 115 may be implemented as a module of any other component of the system 100 or equivalent. In another embodiment, one or more of its modules or components may be implemented as a cloud-based service, local service, native application, or combination thereof. The functions of the vehicle charging module 109, vehicle charging platform 115, and its components are discussed with respect to the figures below.

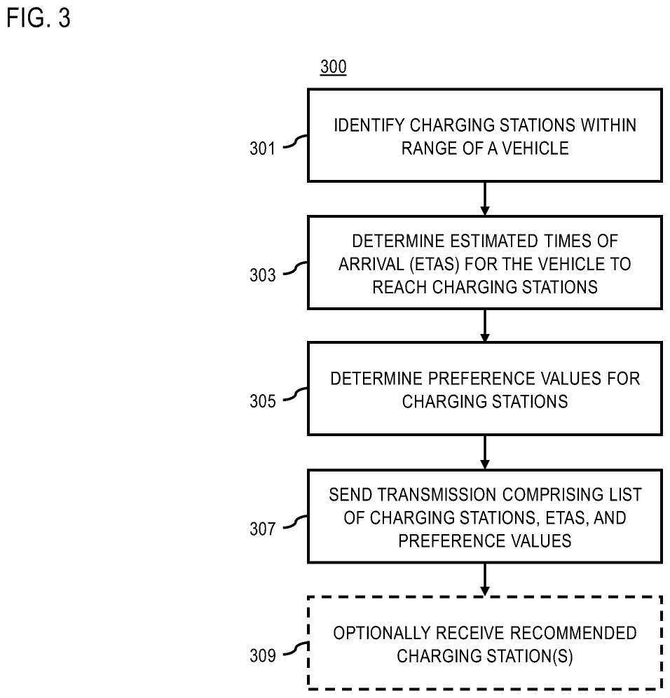

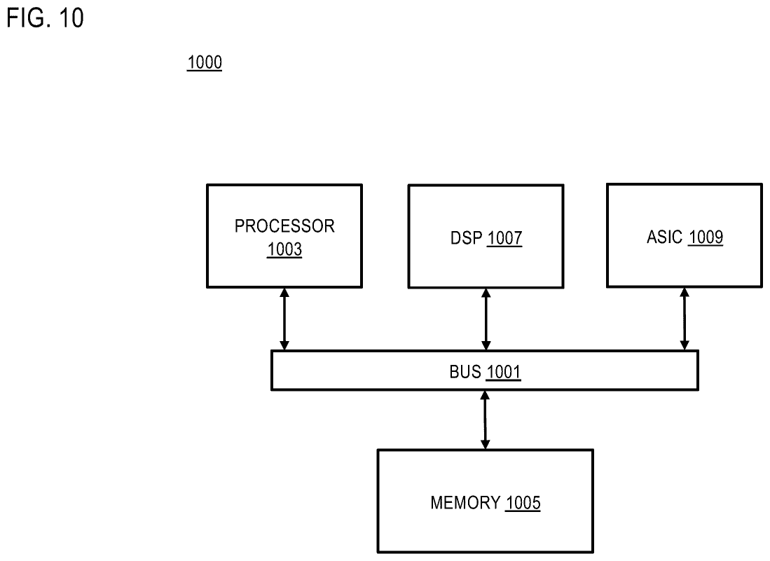

FIG. 3 is a flowchart of a process for providing EV charging station availability from an on-vehicle perspective, according to one example embodiment. In various embodiments, the vehicle charging module 109, vehicle charging platform 115, and/or any of their components may perform one or more portions of the process 300 and may be implemented in, for instance, a chip set including a processor and a memory as shown in FIG. 10 or in circuitry, hardware, firmware, software, or in any combination thereof. As such, the vehicle charging module 109, vehicle charging platform 115, and/or any of their components can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In one embodiment, as discussed above, the process 300 (e.g., on vehicle process) works synergistically with the process 500 (e.g., charging infrastructure process) to provide charging station availability. As used herein, an “on vehicle” process refers to a process that is performed by the vehicle 101 itself (e.g., using internal components such as the vehicle charging module 109, UE 107, application 111, and/or the like), without relying on external communication or computation. In contrast, a “charging infrastructure” process is a process that is performed by the charging infrastructure itself, or by a service provider that operates or manages the charging infrastructure. However, it is noted that while there are processes that are described as either “on vehicle” or “charging infrastructure,” it is contemplated that processes that are ascribed to one process type can be equivalently performed by the processes of the other type.

In one embodiment, the process 300 can be configured to be performed with or without triggering conditions. Triggering conditions can be used to further reduce compute resource usage by only selectively executing the process 300 if those conditions are met. For example, the system 100 can determine and/or flag whether each trip by the vehicle 101 includes an “intent to charge”. An “intent to charge” flag indicates that the vehicle 101 or its driver is expected to include a battery charging session at some point. The “intent to charge” flag can be a binary indicator associated with a data record corresponding to a trip that can be manually set (e.g., by the driver) or automatically determined by system 100 before or during the trip.

In one embodiment, the system 100 can automatically determine that a trip includes an “intent to charge” by the following process. First, each vehicle 101 periodically reads its battery level. For example, the vehicle charging module 109 of each vehicle 101 can interact with a battery management system (BMS) of the vehicle 101, which monitors and controls the battery 105. The BMS measures the voltage, current, temperature, and state of charge (SOC) of each battery cell, and balances the cells to ensure optimal performance and safety. The SOC is an indicator of how much energy is left in the battery, expressed as a percentage of its full capacity. The vehicle 101 can read its battery level by accessing the SOC information from the BMS.

The vehicle 101 then estimates if its current charge is sufficient to reach its destination. To determine this estimate, the vehicle 101 can query the geographic database (e.g., via a navigation system or application) that calculates the distance and the route to the destination, taking into account factors such as traffic, road conditions, speed limits, and elevation changes. The navigation system can also estimate the energy consumption and the battery drain of the electric vehicle along the route, based on its characteristics, such as weight, aerodynamics, powertrain efficiency, and regenerative braking. By comparing the estimated energy consumption with the SOC information from the BMS, the vehicle 101 can determine if it has enough charge to reach the destination, or if it needs to find a charging station along the way. If the current is not sufficient the vehicle 101's current trip can be marked with an “intent to charge” flag.

If the charge is sufficient, the process 300 is not initiated or can otherwise be terminated. The process of checking for sufficient charge to reach a destination can then be restarted after a random period of time, or as soon as preconditions are met, e.g., charge goes below a certain threshold level.

In yet another embodiment, the vehicle charging module 109 can delay initiating the process 300 so that it starts only after a threshold distance and/or time after the vehicle 101 has started driving. In this way, even if the position of the vehicle 101 is triangulated from the information used in providing charging station availability, the vehicle 101 is some distance from the starting point so that it would be more difficult to determine the vehicle 101's origin, thereby enhancing privacy without degrading utility because it is generally not likely that the vehicle 101 will need to charge immediately at the beginning of route.

It is noted that the above optional triggering conditions for process 300 are provided by way of illustration and not as limitations. It is contemplated that other triggering conditions or none at all can be used according to the various embodiments described herein. If the conditions are met or if there are no conditions, the process 300 can start.

In step 301, the charging station module 201 identifies all EV charging stations 103 that are in range (e.g., based on a battery level of the vehicle 101, threshold time/distance proximity to the vehicle 101, threshold time/distance proximity to the route, threshold time/distance proximity to the destination, etc.). In one embodiment, to generate this list of charging stations 103, the charging station module 201 can have access to a list of charging stations 103 with corresponding location and additional optional information such as but not limited to operating hours, charging type, charging compatibility, etc. This information, for instance, can come from a mapping service provider or be stored in the vehicle memory.

For example, the list of one or more charging stations can be determined by querying a geographic database 117 based on one or more predicted ranges of the one or more vehicles. In other words, the charging station module 201 can read the current battery level of the vehicle 101 (e.g., as described above) and then how far the vehicle 101 can drive based on the roads, traffic conditions, weather conditions, vehicle characteristics, etc. (e.g., queried from the geographic database 117) along its route.

For example, in one embodiment, the charging station module 201 can use a reachability graph or isoline routing to compute which charging stations are in range of a vehicle 101. A reachability graph is a data structure that represents the connectivity and distances between the nodes in a network, such as the charging stations 103 and the destinations in a road network. The reachability graph can be constructed by using a shortest path algorithm, such as Dijkstra's algorithm, to find the minimum distance between each pair of nodes, taking into account the energy consumption and the battery drain of the electric vehicle along the edges of the graph, which correspond to the road segments.

To use the reachability graph to find the charging stations that are in range of a vehicle, the charging station module 201 can first identify the vehicle 101's current node and its target node in the graph, e.g., corresponding to the vehicle 101's current location and destination. Then, the charging station module 201 can traverse the graph from its current node, and mark all the nodes that are reachable with its current charge level, e.g., using the SOC information from the BMS and the distance information from the graph. The marked nodes represent the charging stations 103 that are in range of the vehicle 101.

Once the charging station module 201 determines which charging stations 103 are in range, it can then determine which of those charging stations 103 are on the way to the vehicle 101's station. By way of example, the charging station module 201 can use a routing engine to identify which charging stations are on the way to the destination. A routing engine is a software tool that can calculate the optimal route between two locations, considering the road network, the traffic conditions, the weather conditions, and the user preferences. A routing engine can also use machine learning techniques to learn from the historical data and the user feedback, and improve its performance and accuracy over time.

To use a routing engine to find the charging stations that are on the way to the destination, the charging station module 201 can first input its current location and its destination into the routing engine, using the GPS coordinates or the address. Then, the routing engine can search for the optimal route and the optimal charging strategy, using the road network data, the traffic data, the weather data, and the charging infrastructure data. The route planner can display the optimal route, showing the charging stations 103 that are on the way to the destination.

In one embodiment, as noted above, the routing engine can use isoline routing to compute which charging stations are in range of a vehicle 101. By way of example, isoline routing calculates and visualizes the reachable area a vehicle can travel within specific constraints, such as time, distance, fuel/energy consumption, and/or the like. Unlike traditional routing, which focuses on finding the optimal path between two points, isoline routing generates a polygon representing all destinations (e.g., charging stations) reachable within the defined parameters. In one embodiment, the routing engine can use an isoline routing Application Programming Interface (API), provided for instance by mapping service provider, that enables the routing engine to find all destinations that can be reached within the specific constraints described above. The result is an area (e.g., represented as a polygon) where each point within the area can be reached within the provided constraint. In some embodiments, the isoline routing API can also be used to calculate a reverse isoline, that is, finding all starting points from which the center can be reached. In cases where an isoline (e.g., boundary of the polygon representing are that can be reached within the provided constraint) would yield charging stations in all directions from the vehicle 101, the routing engine can filter the results to encompass a heading range towards a destination of the vehicle 101 of interest.

In step 303, the ETA module 203 determines one or more estimated times of arrival (ETA) for the vehicle to reach each of the one or more charging stations 103 (e.g., identified according to the various embodiments described above). To determine the ETAs at each charging station in range, the ETA module 203 can use the steps described below.

First, the ETA module 203 calculates the distance and the travel time from the current location to each charging station in range, using the road network data and the traffic data (e.g., from the geographic database 117). The distance can be measured in kilometers or miles, and the travel time can be measured in minutes or hours. The ETA module 203 subtracts the travel time from the current time to get the estimated time of departure from the current location. The current time can be obtained from the clock or the GPS system and can be expressed in hours and minutes. The ETA module 203 then adds the travel time to the estimated time of departure to get the ETA at each charging station 103 in range. The ETA can also be expressed in hours and minutes and can be adjusted for different time zones if needed.

In one embodiment, in addition or as an alternate to determining ETAs, the ETA module 203 can determine an estimated charge for the vehicle 101 to reach a destination from each of the one or more charging stations 103. For example, the ETA module 203 can compute the predicted battery level of the vehicle 101 when the vehicle 101 is predicted to reach each charging station 103. In one embodiment, this prediction can be determined as follows:
a. Compute a route from a current location of the vehicle 101 to the charging station 103, e.g., via the routing engine as discussed above using map data of the geographic database 117;
b. Compute the current (e.g., real-time) contextual conditions (e.g., traffic, weather, incidents, etc.), e.g., via a real-time data layer of the geographic database 117; and
c. Compute the residual battery level, e.g., by determining the routing distance between the current location of the vehicle 101 and each charging station 103 (e.g., via a routing engine), and then estimating the energy consumption of the vehicle 101 over the determined routing distance (e.g., using EV services that an account for factors relating to energy consumption such as speed, driving style, road conditions, weather conditions, etc.).

In addition or alternatively, the ETA module 203 can compute the minimal charge required to complete the trip (e.g., reach the destination of the vehicle 101) from each charging station 103. This minimal charge represents the minimum battery level to cover the energy consumption of the vehicle 101 expected to be used to reach the destination. The ETA module 203 can also determine a charging duration at each of the one or more charging stations 103 for the one or more vehicles to achieve a charging level predicted for the one or more vehicles 101 to reach one or more respective destinations. The respective probabilities that the vehicle 101 is expected to use a particular charging station 103 (e.g., as computed according to various embodiments described further below) can be further based on the charging duration. In addition or alternatively, the ETA module 203 can determine whether charging capabilities are available at the destination and then tune predicted charging duration, charging level, etc. at the charging stations 103 accordingly. For example, if the destination is a private home with EV charging capabilities installed, the potential to charge at the destination can be taken into account to tune the charging duration and/or charging levels needed at a prior charging station 103. In one scenario, for instance, if the vehicle 101 can charge at the destination, the vehicle 103 can be charged to a lower level (thereby requiring a shorter charging duration) because it will not need to account charge needed to travel away from the destination.

In one embodiment, if the destination is too far (e.g., further than a threshold distance, further than distance that that the vehicle 101 can travel after charging at the maximum designated charging duration), the process 3003 can start from the beginning to identify further charging options, e.g., when starting again from a selected charging station 103 and evaluating the second leg of the trip from the selected charging station 103. In one embodiment, the vehicle charging station module 201 can remove a charging station from the list of the one or more charging stations 103 (e.g., candidate charging stations) or otherwise eliminate a charging station 103 from further consideration in the process 300 by determining that the charging station 103 is farther than a threshold distance from a destination of the vehicle 101.

In step 305, after determining ETA data and/or related charging information according to the various embodiments of step 303, the preference module 205 determines one or more preference values computed to indicate a preference of the vehicle 101 to reach each of the one or more charging stations 103. As used herein, a preference of the vehicle 101 to reach each of the one or more charging stations 103 is a measure of how desirable or suitable it is for the vehicle to travel to a given charging station, based on various preference parameters or factors. In one embodiment, the preference value is a numerical value or score computed from the preference factors. The preference value, for instance, can be normalized to a designated range (e.g., 0.0-1.0 or equivalent wherein 0.0 indicates the lowest probability and 1.0 indicates the highest probability). This way, the preference value can be more easily compared across different charging stations 103. In addition, many of the factors (e.g., charging speed, accessibility, route preferences, charging fees, amenities, payment options, loyalty programs, ratings, etc.) that yield a preference value may be considered personal or privacy sensitive information, for instance, because they pertain to the specific routes taken by the different vehicles 101. Thus, by reducing said preferences to a normalized value, the nature of those factors is further obfuscated, but still provides useful input to the probability calculation. Additionally, these factors can be learned by an machine learning (ML) model (e.g., recommender system) and kept private by running the ML model locally on a device (e.g., UE 107) of the driver.

Examples of preference factors and how they are used to compute the preference value include but are limited to:
a. The preference value is proportional to the delay in reaching the destination that each charge would add, e.g., computed based on routing engines/services, ETA prediction, and/or the like based on the mapping data of the geographic database 117. In other words, the one or more preference values are computed based on a delay in reaching one or more destinations by the one or more vehicles 101 caused by detouring to and charging at the one or more charging stations 103. One example of computing the delay includes but is not limited to comparing the travel time of the original route and the modified route (e.g., route detouring to the charging station 103). The travel time of a route can be estimated by dividing the distance of the route by the average speed of the vehicle. The distance of the original route is the direct distance from the current location to the destination. The distance of the modified route is the sum of the distances from the current location to the charging station 103, from the charging station 103 to the destination, and any additional distance due to road conditions or traffic. The average speed of the vehicle can be calculated from historical data or real-time information. The travel time of the modified route also includes the time spent at the charging station 103, which depends on the charging speed, the battery level, and the desired state of charge. The delay is then the difference between the travel time of the modified route and the travel time of the original route.
b. The preference value is proportional to the cost of charging at each charging station 103. In one embodiment, the cost or prices for charging can be stored and maintain the point of interest (POI) data of the geographic database 117. In one embodiment, the geographic database 117 or equivalent database can store information about individual charging stations 103 and their pricing. The database can include fields for the station's unique identifier, location, connector types available (e.g., CCS, CHAdeMO), and real-time pricing data. Additionally, the database could hold historical pricing information to track trends and inform future pricing models. For efficient updates, the database should be designed to integrate with data feeds from the grid operator and individual charging stations 103, ensuring the pricing information remains constantly current.
c. The preference value is proportional to the expected/predicted charge time, e.g., determine based on characteristics of each charging station 103 (e.g., nearby amenities, payment options, loyalty programs, ratings, etc.) as stored in the geographic database 117 or equivalent. In one embodiment, to determine the expected or predicted charge time for a vehicle 101 at a charging station 102, several factors can be considered. For example, the preference module 205 can identify the vehicle 101's battery capacity, typically measured in kilowatt-hours (kWh). Next, the charging station 103's power output can be determined, usually in kilowatts (kW), which determines the rate at which energy can be transferred to the vehicle 101. Then, the current state of charge of the battery can be used to estimate the amount of energy needed to reach a designated charge level (e.g., minimal charge level to reach the destination). The estimated charging time can then be determined based on the required energy and the charging station's power output. In some embodiments, advanced charging stations 103 or vehicles 101 may provide real-time data on charging progress, allowing for more accurate predictions. Monitoring and adjusting based on these factors can help optimize the charging process and provide a more precise estimate of the charging time.

It is noted that the above example factors for determining preference values for a charging station 103 are provided by way of illustration and not as limitations. It is contemplated that any equivalent factor that is indicative of how one charging station is preferred by a vehicle 101/driver over another charging station can be used according to the various embodiments described herein.

In step 307, the output module 209 sends or otherwise initiates a transmission comprising a list of the one or more charging stations 103 (e.g., as identified according to step 301), the one or more estimated times of arrival (e.g., as determined according to step 303), and the one or more preference values (e.g., as determined according to step 305). For example, the output module 209 sends this information (e.g., list of charging stations with ETA, required charging time, preference) to the service provider (e.g., vehicle charging platform 115 or equivalent) over the communication network 108.

In one embodiment, the information can be transmitted anonymously such that the service provider (e.g., vehicle charging platform 115) cannot triangulate the position of the transmitting vehicle 101 from the ETAs to the various charging stations 103. In other words, the one or more transmissions can be anonymized to prevent determination (e.g., via triangulation or equivalent) of respective positions of the one or more vehicles. By way of example, anonymization can include but is not limited to using random vehicle identifiers for charging station 103, adding random noise to the ETAs, and/or the like.

However, in some cases, it might be desirable to keep track of a vehicle 101's preferences over time, to maintain data fresh, e.g., a vehicle 101 might communicate a set of preferences at time t, identify a traffic jam at t+1 and recompute a new set of preferences at time t+2. In this case, it can be useful to replace the information transmitted at time t with that at time t+2. Anonymization can potentially prevent such useful tracking.

Accordingly, in one embodiment, to keep track of preferences over time, the output module 209 can use an ID computed as a hash of: (1) vehicle/trip ID—e.g., rotated at every power cycle or any other designated interval; (2) charging station ID; and (3) a random salt-generated together with the vehicle/trip ID, to prevent retrieving the vehicle ID from the hash and the station ID. In this way, identification information of the one or more vehicles is anonymized as a hash of a vehicle identifier, a trip identifier, a charging station identifier, a random salt, or a combination thereof. Such an ID would enable a certain degree of tracking, as the service provider (e.g., vehicle charging platform 115) obtains the distance of the vehicle 101 with respect to one specific charging station 103 at multiple points in time. However, the tracking ability is limited as, having only the ETA to a specific location, it might not be possible to determine the direction of travel of the vehicle 101 with respect to the charging station 103—only if the vehicle is getting closer or farther from the charging station 103.

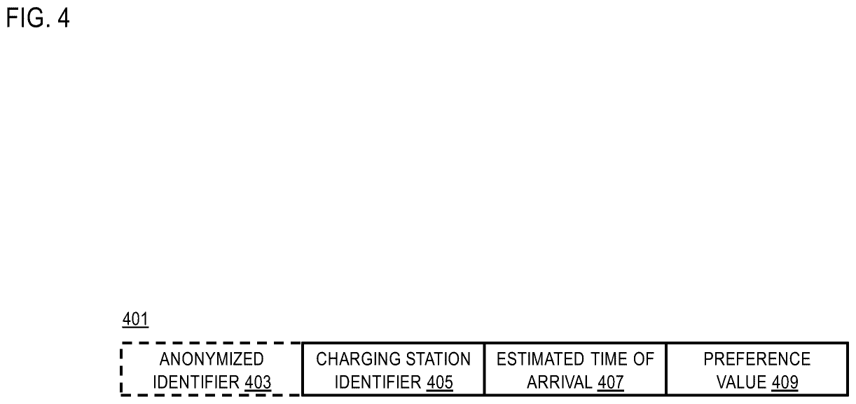

In one embodiment, the output module 209 can transmit the information described above (e.g., charging station transmissions 119) in a data format that reduces the amount of data that is transmitted when compared to traditional approaches that transmit the full trajectories of vehicles 101. FIG. 4 is a diagram of a data format 401 for transmitting EV charging information, according to one example embodiment. As shown, the one or more transmissions are in a data format 401 comprising an optional anonymized identifier data field 403, a charging station identifier data field 405, an estimated time of arrival data field 407, and a preference value data field 409. The anonymized identifier data filed 403 can be computed as described in the various embodiments discussed above and can be used, for instance, when preference tracking over time is configured. The charging station identifier data field 405 stores a unique identifier associated with each charging station (e.g., corresponding to the identifier of the used in the geographic database 117). The estimated time or arrival data field 407 stores the ETA determined for each charging station from the current location of a corresponding vehicle 101 according to the various embodiments described herein.

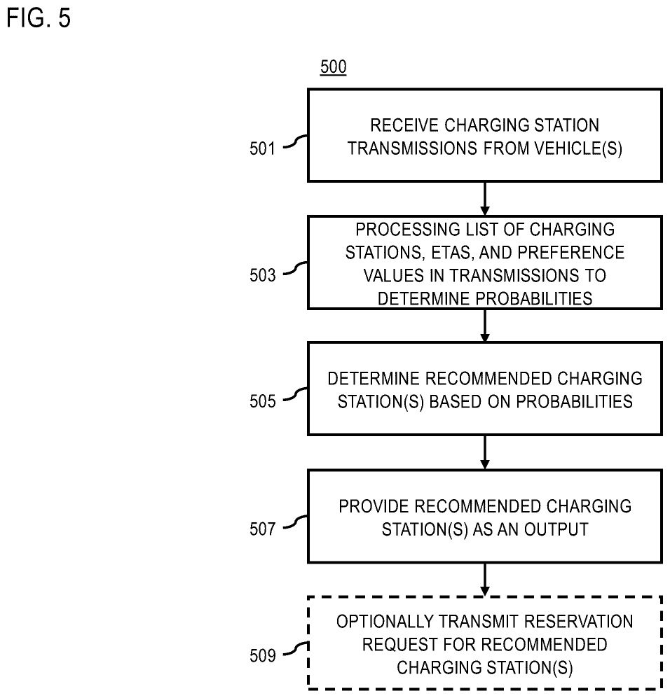

In one embodiment, in response to a charging station transmission 119, the vehicle charging module 109 receives from the service provider (e.g., vehicle charging platform 115) probabilities that each of the charging stations 103 in the charging station transmission 119 would be available at the desired time (e.g., at the computed ETA). For example, the service provider (e.g., via the vehicle charging platform 115 as described below with respect to FIG. 5) uses the one or more charging stations 103, the one or more estimated times of arrival, and the one or more preference values to determine respective probabilities that each of the one or more charging stations 103 will be available at the one or more estimated times of arrival. In one embodiment, if estimated charge levels are also determined, the respective probabilities are determined further based on the estimated charge.

In one embodiment, the service provider can also suggest one or more charging options to the driver, based on the probabilities and the preference values. In other words, the vehicle charging module can receive at least one recommended charging station determined from among the one or more charging stations 103 based on the transmission, and wherein the at least one recommended charging station is based on the respective probabilities of availability of charging slots at the charging stations 103 of interest.

In one embodiment, the vehicle charging module 109 (e.g., via the service interface 211) can optionally reserve the recommended charging station 103, either via the service provider (e.g., vehicle charging platform 115) or by directly contacting the charging station 103 (e.g., via the services platform 123 and/or one or more of the services 125 of the service platform 123). For example, the vehicle charging module or the vehicle charging platform 115 can automatically transmit a reservation request to a server to reserve the at least one recommended charging station for the vehicle. Once a recommendation is generated, the service interface 211 automatically initiates a reservation process (i.e., without manual intervention), synchronizing the reservation timing with the vehicle 101's estimated arrival at the designated charging station 103. For example, this reservation can be confirmed through notifications sent to the user, containing essential details such as the station location, reserved slot number (if applicable), and estimated charging duration. Additionally, in one embodiment and to enhance convenience, the reservation information can be integrated into the vehicle 101's navigation system, facilitating effortless navigation to the reserved charging station 103.

In one embodiment, in a scenario in which the vehicle charging module 109 is keeping track of user preferences for a given station over time with an ID as described above, if the charging station reservation is successful reservation, the service interface 211 can send an update to the previously considered alternative charging stations (or service providers operating the alternative charging stations) informing that the charging station can stop planning for the vehicle 101's arrival. If the reserved charging station shares availability information, a similar message can also be sent about this charging station so that the vehicle 101 is not double counted. The service interface 211 can also notify other vehicles 101 that were considering charging at the station that the station is now free and to prompt the user about switching to that station.

In summary, the service interface 211 can automatically transmit a reservation request to a server (e.g., of a charging station service provider) to reserve the at least one recommended charging station for the one or more vehicles. The service interface 211 can then receive a confirmation from the server that the reservation request is successful. In response, the service interface 211 can automatically transmit an update message to at least one other charging station of the one or more charging stations that the one or more vehicles will not be coming to the at least one other charging station.

FIG. 5 is a flowchart of a process for providing EV charging station availability from a charging infrastructure perspective, according to one example embodiment. In various embodiments, the vehicle charging module 109, vehicle charging platform 115, and/or any of their components may perform one or more portions of the process 500 and may be implemented in, for instance, a chip set including a processor and a memory as shown in FIG. 10 or in circuitry, hardware, firmware, software, or in any combination thereof. As such, the vehicle charging module 109, vehicle charging platform 115, and/or any of their components can provide means for accomplishing various parts of the process 500, as well as means for accomplishing embodiments of other processes described herein in conjunction with other components of the system 100. Although the process 500 is illustrated and described as a sequence of steps, it is contemplated that various embodiments of the process 500 may be performed in any order or combination and need not include all of the illustrated steps.

As described above, the process 500 works synergistically with the process 300 to provide charging station availability from the charging infrastructure or service provider side. It is assumed that vehicles 101 are generating charging station transmissions 119 according to the various embodiments of the process 300 and transmitting the updates (e.g., in the format described with respect to FIG. 4 or equivalent) to the vehicle charging platform 115 for aggregation and processing.

In step 501, the charging station module 201 of the vehicle charging platform 115 (e.g., operated by a service provider) receives updates from EVs in the format (EV charging station, ETA, preference). In one embodiment, the updates are received asynchronously at no fixed schedule such that the updates can arrive at any time depending on triggering conditions of the individual vehicles 101 (e.g., based on determining that the vehicle 101 is on an “intent to charge” trip or route). In other words, the charging station module 201 receives one or more transmissions (e.g., charging station transmissions 119) from one or more vehicles 101. Each of the one or more transmissions comprises a list of one or more charging stations 103 (e.g., with range of the reporting vehicle 101), one or more estimated times of arrival for the one or more vehicles 101 to reach each of the one or more charging stations 103, and one or more preference values computed to indicate a preference of the one or more vehicles 101 to reach each of the one or more charging stations 103. As indicated, the updates (i.e., charging station transmissions 119) are generated according to the various embodiments of the process 300.

In step 503, the data processing module 207 processes the list of the one or more charging stations 103, the one or more estimated times of arrival, and the one or more preference values to determine respective probabilities that each of the one or more charging stations will be available at the one or more estimated times of arrival. In other words, the data processing module 207 converts the information received in the charging station transmissions 119 into a probability of the vehicle 101 charging at the specific charging station 103 at the specific time.

In one embodiment, the probability of the vehicle 101 visiting each charging station 103 can be based on a total weighted preference binned according to the ETA and/or estimated charging time (if provided) at each station 103. The total weighted preference can be computed, for instance, as a normalized sum up to 1 of the preference values of each charging station 103 reported by a vehicle 101. The charging station 103 associated with the highest preference value or weighted preference can have the highest probability of being visited by the corresponding vehicle 101. The data processing module 207 aggregates this preference by ETA time epochs to determine the number of vehicles 101 preferring a particular charging station 103 at a particular time epoch. The availability of charging slots at the charging station 103 can then be determined by subtracting the number of vehicles preferring a particular charging station 103 at a particular time epoch from the total number of available charging slots for the particular time epoch. A negative or zero number result indicates that the charging station 103 may be overbooked for that time epoch and would be expected to have no availability. On the other hand, a positive number result represents the expected number of available slots at the particular charging station 103 at the particular time epoch.

In one embodiment, the data processing module 207 can use a machine learning approach to learn and predict the probability from the reported charging stations, ETAs, and preference values. It is contemplated that as the number of EVs increases, the number of vehicle 101 generating charging station transmissions 119 and requesting real-time charging station availability will increase to a volume that would be practically impossible for manual processing of the information to provide charging availability information before the information is out of date (e.g., no longer reflective of real-time conditions). This is because turnover and charging times at charging stations 103 can be relatively quick (e.g., within 30 mins to 1 hour or quicker) depending on the speed of charging.

In one embodiment, the data processing module 207 can combine updates or charging station transmissions 119 received from one vehicle 101 with any similar information previously received (e.g., from or by other vehicles 101) to determine respective probabilities that one or more charging stations 103 would be available. Because the aggregate or combined information does not include full trajectory data and may also be anonymized, the system 100 can advantageously provide charging station availability information without having to know the individual routes or battery levels of a vehicle, thereby providing increase privacy protection over traditional approaches. If user preference to charge at a given charging station is tracked over time with an anonymized ID unique to driver/vehicle 101, trip, and charging station 103 as described above, on arrival of a new message all previous messages with the same ID are no longer taken into consideration in the following computations. This prevents service quality being degraded by the inclusion of outdated data in the availability estimates. On the other hand, if user preference is not tracked over time, previous information can be discounted over time (e.g., after a threshold time period) to keep freshness in the estimates.

In one embodiment, the data processing module 207 can combine charging station transmissions 119 with data from current charging station availability, e.g., coming from connected charging stations 103 that report their availability in real-time. In other words, an availability of the one or more charging stations is based on the one or more charging stations having one or more available charging slots at the one or more estimated times of arrival, and this future availability can be further based on data indicating current availability of the charging stations 103. In this way, the data processing module 207 computes a probability of the charging station having one or more free charging slots at the specific time.

In one embodiment, the output module 209 can communicate the determined probability with the vehicle 101 that provided the update/charging station transmission 119. In some embodiments, the probability can also be communicated to other vehicles 101 that are, for instance, on the same route or within a threshold proximity of the vehicle 101 that provided the update. In addition or alternatively, the output module 209 can save the compute probabilities and/or related charging station availability information in a central database for later use. For example, the probabilities and information can be stored in the POI data or any other data layer of the geographic database 117 associated with data records for the individual charging stations 103.

In yet another embodiment, the output module 209 can send or interact with one or more other notification services (e.g., operated by an Original Equipment Manufacturer (OEM)), to send proactive notifications (e.g., push notifications without a specific request from a vehicle) about the availability, probabilities of availability, and/or changes the availability of charging stations. For example, the output module 209 and/or other server can send notifications (e.g., push notifications) whenever the availability of a charging station changes, e.g., resulting from a vehicle which is not part of the system begins charging, or requests from many vehicles arrive for a specific charging station. In these cases, the output module 209 can promptly notify vehicles 101 (e.g., on determining or otherwise receiving information that charging station availability has changed), instead of waiting for each vehicle 101 to ask for an update.

In one embodiment, the output module 209 can achieve this by keeping a database of charging station identifiers with a list of vehicles 101 that expressed interest in them. The database can further include the internet protocol (IP) address or equivalent, in order to forward the proactive or push notification. Then, any time a charging station availability status updates, a notification is sent to the IP addresses of the recorded vehicles 101.

For privacy considerations, the database does not store the timestamps indicating when a vehicle 101 is in proximity to each list along the route of a vehicle 101, thereby making it difficult to determine the direction of the vehicle 101's trip. Additionally, IP addresses for the vehicles 101 can change at every power cycle to further reduce the potential for tracking individual vehicles 101. In some cases, linking this database with user preferences data might be possible by tracking changes over time and associating each IP address with an obfuscated vehicle ID based on the common charging station IDs. To separate the two databases and prevent linkage, the push notification process can be managed by an OEM or other service provider that is independent and separate from the vehicle charging system 115.

In step 505, the data processing module 207 determines at least one recommended charging station from among the one or more charging stations 103 based on the respective probabilities. For example, the recommended charging station can be the station that is within range with the highest probability of having available charging slots. In one embodiment, the probabilities can be further weighted based on additional parameters such as but not limited to proximity to other POIs, amenities at the charging station, ease of access, scheduled maintenance, and/or the like.

In step 507, the output module 209 provides the at least one recommended charging station as an output. By way of example, the service provider can deliver the recommended charging station as an output to the vehicle 101 and/or its driver through various channels. Firstly, the recommendation can be transmitted directly to the vehicle 101's onboard navigation system, enabling the driver to receive real-time guidance to the recommended charging station. This integration allows for a hands-free and intuitive user experience, with turn-by-turn directions provided directly within the vehicle interface. Additionally, the recommendation can be communicated to the driver through the application 111, displayed on the driver's smartphone (e.g., UE 107) or infotainment system. This approach offers flexibility and convenience, allowing the driver to access the recommendation from their preferred device and follow the provided instructions. Furthermore, the recommendation can be accompanied by additional details such as the charging station 103's location, ETA, available charging speed, pricing information, and any relevant amenities, providing the driver with comprehensive information to make an informed decision.

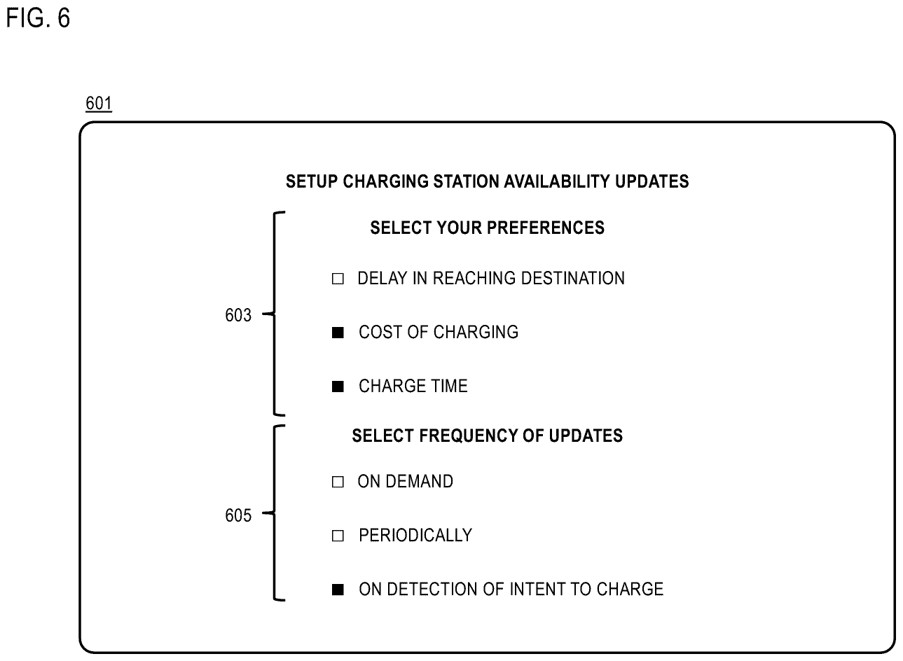

FIG. 6 is a diagram of an example user interface (UI) 601 for setting preferences for generating EV charging station updates, according to one example embodiment. Example UI 601 can be presented by the vehicle charging module 109 to configure a service for providing EV charging station updates (e.g., charging station transmissions 119) from a vehicle 101. In this example, example UI 601 presents a section 603 for selecting the parameters that will be used to compute preference values for reaching one or more charging stations 103 that are within range of the vehicle 101 (e.g., determined according to various embodiments of process 300). The user has selected parameters for “cost of charging” and “charge time,” and has not selected “delay in reaching destination.” Accordingly, the vehicle charging module 109 is configured to compute the preference value such that the value is inversely proportional to the cost of charging and charge time. As the cost of charging increases for a charging station 103, its preference value decreases and vice versa. Similarly, as the charge time increases for a charging station 103, its preference value decreases and vice versa.

Example UI 601 also presents a section 605 for selecting how often EV charging station updates or transmissions 119 are generated and transmitted to a service provider (e.g., the vehicle charging platform 115). In this example the frequency options include “on demand,” “periodically,” and “on detection of intent of charge.” “On demand” is an option whereby the driver manually initiates any update or charging station transmission 119. For example, the vehicle charging module 109 can provide another UI (not shown) that includes a UI element (e.g., on screen button, toggle, control, etc.) to initiate a manual update. “Periodically” is an option whereby the vehicle charging module 109 will initiate updates at a fixed frequency regardless of any other triggering condition. The fixed frequency can be a default frequency set by the system 100 or configured by the user. “On detection of intent to charge” is an option whereby the vehicle charging module 109 monitors the start of each trip or drive to determine whether the vehicle 101 will be charged during some point on the trip. As previously discussed, the “intent to charge” can be based on determining that there is an insufficient current charge level to reach the vehicle 101's destination. In other cases, the “intent to charge” can be based on preference or historical patterns. For example, if the user always charges when commuting home from work on weekdays, the vehicle charging module 109 can monitor the vehicle 101's mobility pattern to determine whether it is on a trip from home to work on a weekday, and then flag the trip as an “intent to charge” trip.

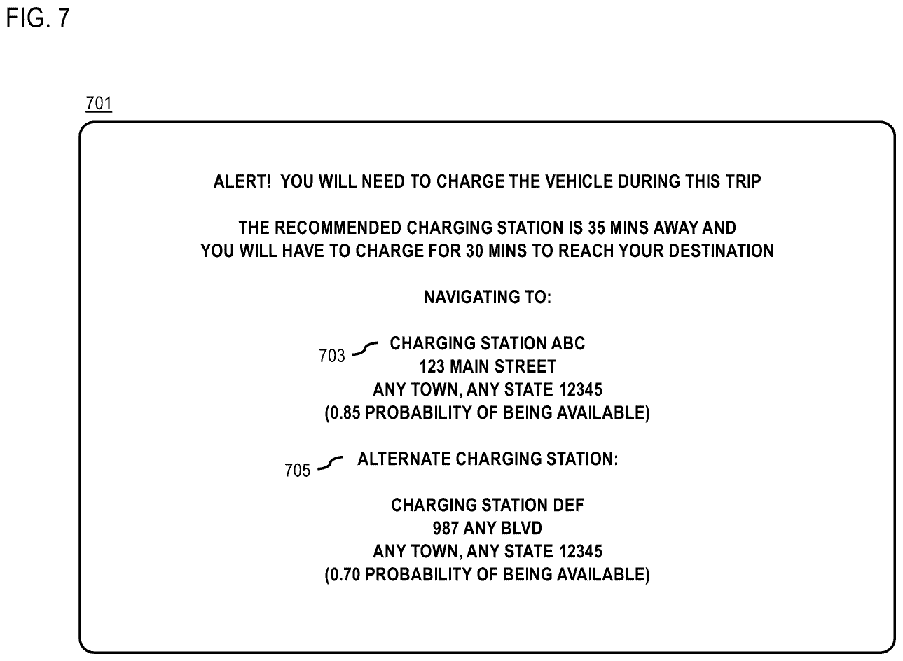

FIG. 7 is a diagram of an example user interface (UI) 701 for providing EV charging station availability, according to one example embodiment. The example of FIG. 7 continues the example of example of FIG. 6 and illustrates a scenario in which updates transmitted based on the settings of the example of FIG. 6 is used in providing charging availability information that is presented in FIG. 7. In this example, the vehicle charging module 109 determines that for a current trip by vehicle 101, there is insufficient charge to reach the destination. As a result, the vehicle charging module 109 has flagged the trip as an “intent to charge” trip and initiated charging station transmissions 119 (e.g., generated according to process 300) to the service provider (e.g., vehicle charging platform 115). In response, the vehicle charging platform 115 has aggregated the vehicle 101's charging station transmissions 119 with updates from other vehicles to provide real-time charging station availability. More specifically, the vehicle charging platform 115 has evaluated the charging stations 103 identified by the vehicle 101 to determine respective probabilities that charging slots will be available based on the ETA of the vehicle 101 at each charging station 103 (e.g., determined according to the various embodiments of process 500).

The charging station transmissions 119/updates from the vehicle provide a list of the identified charging stations 103 within range of the vehicle, ETA of the vehicle 101, and preference values for each charging station 103. In this example, the preference values are based on “cost of charging” and “charging time” (see FIG. 6). So, the resulting probabilities also include components of these parameters. That is, a charging station 103 that has lower cost will be more likely to be preferred by the vehicle 101 and/or any other reporting vehicle with “cost of charging” as a selected factor. This preference increases the likelihood that any vehicle preferring a lower “cost of charging” would visit a charging station 103 with lower pricing. This can have an impact on its probability of availability.

As shown, example UI 701 presents an alert that “You will need to charge the vehicle during this trip” and presents a recommended charging station 703 with the highest probability of availability (0.85) and notifying the driver that “the recommended charging station is 35 mins away and you will have to charge for 30 mins to reach your destination”. Example UI 701 also presents an alternate charging station 705 that has the next highest probability of availability (0.70) as a possible option for the user to select. If the user does not select the alternate charging station 705, example UI 701 can continue by presenting a navigation guidance UI (not shown) to direct the driver to the recommended charging station 703.

Returning to FIG. 1, as shown, and discussed above, the system 100 includes the vehicle charging module 109 and vehicle charging platform 115 for providing privacy preserving EV charging station availability alone or in combination. In one embodiment, the vehicle charging module 109, vehicle charging platform 115, and/or other components of the system 100 have connectivity or access to a one or more databases (e.g., geographic database 117) for accessing mapping data and storing EV charging station related data generated or used according to the various embodiments described herein. In one embodiment, the geographic database 117 can include electronic or digital representations of mapped geographic features, places, POIs, charging stations, etc. In one embodiment, the system 100 also includes or otherwise has access to the service platform 123 and/or one or more services 125 that use the outputs of the vehicle charging module 109 and/or vehicle charging platform 115 (e.g., charging station recommendations 121, charging station probability of availability, charging station transmissions 119/updates). These services or applications include, but are not limited to, autonomous/semi-autonomous vehicle operation, EV charging services, mapping services, navigation services, travel planning services, notification services, social networking services, content (e.g., audio, video, images, etc.) provisioning services, application services, storage services, contextual information determination services, location-based services, information-based services (e.g., weather, news, etc.), etc.

In one embodiment, the vehicle charging module 109 and vehicle charging platform 115 may be or include a platform with multiple interconnected components. The platform may include multiple servers, intelligent networking devices, computing devices, components, and corresponding software for providing EV charging station availability according to various embodiments described herein.

In one embodiment, the vehicle charging module 109, UE 107, and/or vehicle 101 may execute a software application 111 for providing EV charging station availability according to the embodiments described herein. By way of example, the application 111 may also be any type of application that is executable on the vehicle charging module 109, UE 107, and/or vehicle 101, such as autonomous driving applications, mapping applications, location-based service applications, navigation applications, content provisioning services, camera/imaging application, media player applications, social networking applications, calendar applications, and the like. In one embodiment, the vehicle charging module 109 and/or application 111 may act as a client for the components of the vehicle charging platform 115 and perform one or more functions associated with providing EV charging station availability alone or in combination with the cloud components.

By way of example, the UE 107 and/or any of component of the vehicle 101 can be any type of embedded system, mobile terminal, or portable terminal including a built-in navigation system, a personal navigation device, mobile handset, station, unit, device, multimedia computer, multimedia tablet, Internet node, communicator, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 107 can support any type of interface to the user (such as “wearable” circuitry, etc.). In one embodiment, the UE 107 may be associated with the vehicle 101 or be a component part of the vehicle 101.

In one optional embodiment, the UE 107 and/or vehicle 101 are configured with various sensors for generating or collecting sensor observations (e.g., for processing by the system 100), related geographic data, etc. In one embodiment, the sensed data represents sensor data associated with a geographic location or coordinates at which the sensor data was collected to detect or validate map feedback reports. In this way, the sensor data can act as observation data that can be processed to provide contextual information for providing EV charging station availability according to the various embodiments described herein. By way of example, the sensors may include a global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road boundaries, road sign information, images of road obstructions, etc. for analysis), LiDAR, Inertial Measurement Units (IMUs) for e.g. performing dead-reckoning, radar, an audio recorder for gathering audio data, velocity sensors mounted on steering wheels of the vehicles, switch sensors for determining whether one or more vehicle switches are engaged, and the like.

Other examples of optional sensors of the UE 107 and/or vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle along a path of travel, moisture sensors, pressure sensors, etc. In a further example embodiment, sensors about the perimeter of the UE 107 and/or vehicle 101 may detect the relative distance of the vehicle 101 to a road boundary, the presence of other vehicles, pedestrians, traffic lights, potholes and any other objects, or a combination thereof. In one scenario, the sensors may detect weather data, traffic information, or a combination thereof. In one embodiment, the UE 107 and/or vehicle 101 may include GPS or other satellite-based receivers to obtain geographic coordinates or signal for determine the coordinates from satellites. Further, the location can be determined by visual odometry, triangulation systems such as A-GPS, Cell of Origin, or other location extrapolation technologies. In yet another embodiment, the sensors can determine the status of various control elements of the vehicle, such as activation of wipers, use of a brake pedal, use of an acceleration pedal, angle of the steering wheel, activation of hazard lights, activation of head lights, etc.

In another optional embodiment, the communication network 108 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), 5G New Radio networks, Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the components of the system 100 communicate with each other and other components using well known, new or still developing protocols. In this context, a protocol includes a set of rules defining how the network nodes within the communication network 108 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

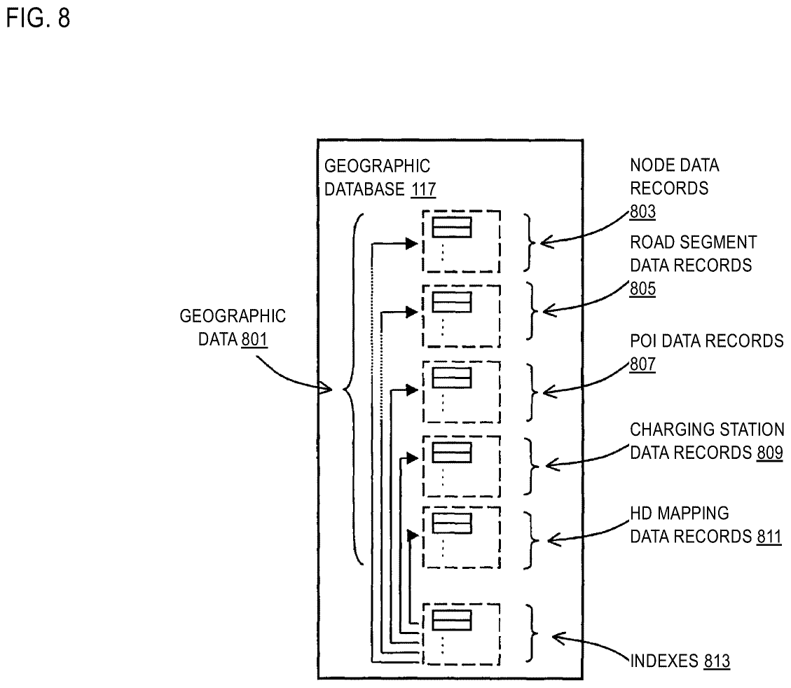

FIG. 8 is a diagram of the geographic database 117, according to one embodiment. In one embodiment, the geographic database 117 includes geographic data 801 used for (or configured to be compiled to be used for) mapping and/or navigation-related services. In one embodiment, geographic features (e.g., two-dimensional, or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 117.
“Node”—A point that terminates a link.
“Line segment”—A straight line connecting two points.
“Link” (or “edge”)—A contiguous, non-branching string of one or more line segments terminating in a node at each end.
“Shape point”—A point along a link between two nodes (e.g., used to alter a shape of the link without defining new nodes).
“Oriented link”—A link that has a starting node (referred to as the “reference node”) and an ending node (referred to as the “non reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 117 follows certain conventions. For example, links do not cross themselves and do not cross each other except at a node. Also, there are no duplicated shape points, nodes, or links. Two links that connect each other have a common node. In the geographic database 117, overlapping geographic features are represented by overlapping polygons. When polygons overlap, the boundary of one polygon crosses the boundary of the other polygon. In the geographic database 117, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 117 includes node data records 803, road segment or link data records 805, POI data records 807, charging station data records 809, other records 811, and indexes 813, for example. More, fewer, or different data records can be provided. In one embodiment, additional data records (not shown) can include cartographic (“carto”) data records, routing data, and maneuver data. In one embodiment, the indexes 813 may improve the speed of data retrieval operations in the geographic database 117. In one embodiment, the indexes 813 may be used to quickly locate data without having to search every row in the geographic database 117 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points (such as intersections) corresponding to the respective links or segments of the road segment data records 805. The road link data records 805 and the node data records 803 represent a road network, such as used by vehicles, cars, and/or other entities. Alternatively, the geographic database 117 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as charging stations 103, gasoline stations, hotels, restaurants, museums, stadiums, offices, automobile dealerships, auto repair shops, buildings, stores, parks, etc. The geographic database 117 can include data about the POIs and their respective locations in the POI data records 807. The geographic database 117 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city).

In one embodiment, the geographic database 117 can also include charging station data records 809 for storing charging station transmission 119, computed probabilities of charging station availability, charging station recommendations 121, and/or any other related information/data used and/or generated according to the various embodiments described herein. In one embodiment, the charging station data records 809 can be associated with one or more of the node records 803, road segment records 805, and/or POI data records 807 to associate the charging station data with specific geographic locations. In this way, the charging station data can also be associated with the characteristics or metadata of the corresponding record 803, 805, and/or 807.

In one embodiment, the geographic database 117 can be maintained by content providers (e.g., a map developer or service provider). The map developer or service provider can collect geographic data to generate and enhance the geographic database 117. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 117 can be a master geographic database stored in a format that facilitates updating, maintenance, and development. For example, the master geographic database or data in the master geographic database can be in an Oracle spatial format or other spatial format, such as for development or production purposes. Map layers may be utilized. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing EV charging station availability may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

FIG. 9 illustrates a computer system 900 upon which an embodiment of the invention may be implemented. Computer system 900 is programmed (e.g., via computer program code or instructions) to provide EV charging station availability as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to providing EV charging station availability. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing EV charging station availability. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk, or flash card, for storing information, including instructions, that persists even when the computer system 900 is turned off or otherwise loses power.

Information, including instructions for providing EV charging station availability, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic, or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 108 for providing EV charging station availability.

The term computer-readable medium is used herein to refer to any medium that participates in providing information to processor 902, including instructions for execution. Such a medium may take many forms, including, but not limited to, non-volatile media, volatile media, and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of the system can be deployed in various configurations within other computer systems, e.g., host 982 and server 992.

FIG. 10 illustrates a chip set 1000 upon which an embodiment of the invention may be implemented. Chip set 1000 is programmed to provide EV charging station availability as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide EV charging station availability. The memory 1005 also stores the data associated with or generated by the execution of the inventive steps.

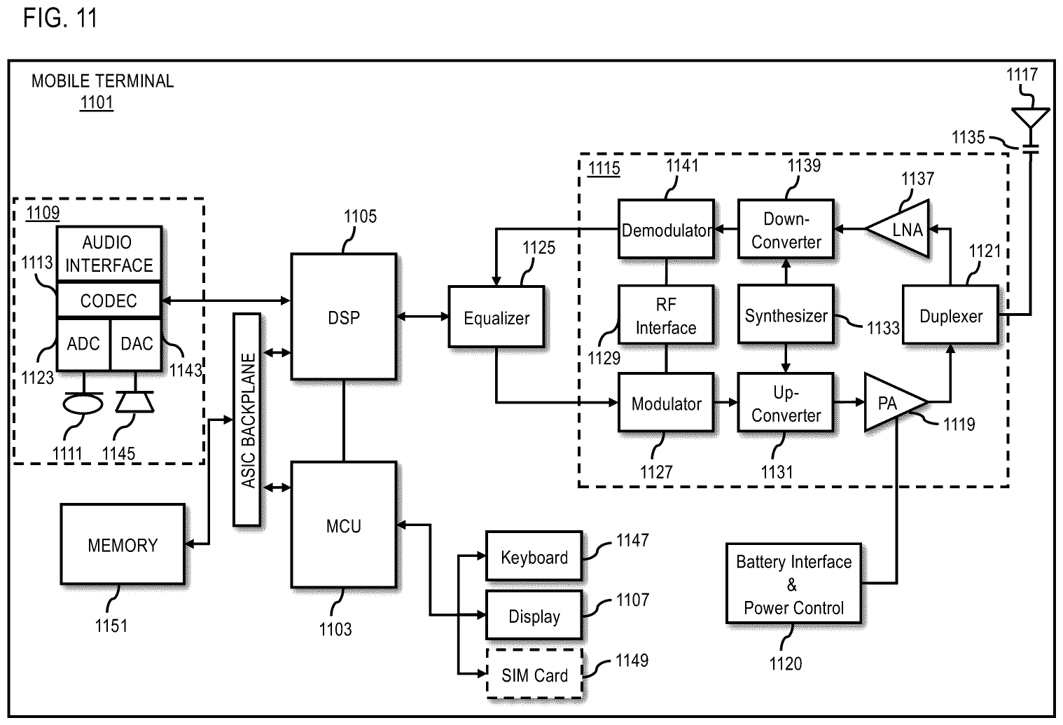

FIG. 11 is a diagram of exemplary components of a mobile terminal 1101 (e.g., UE 107, vehicle 101, or component thereof) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with an RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to provide EV charging station availability. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving one or more transmissions from one or more vehicles, wherein each of the one or more transmissions comprises a list of one or more charging stations, one or more estimated times of arrival for the one or more vehicles to reach each of the one or more charging stations, and one or more preference values computed to indicate a preference of the one or more vehicles to reach each of the one or more charging stations;
processing the list of the one or more charging stations, the one or more estimated times of arrival, and the one or more preference values to determine respective probabilities that each of the one or more charging stations will be available at the one or more estimated times of arrival;
determining at least one recommended charging station from among the one or more charging stations based on the respective probabilities; and
providing the at least one recommended charging station as an output.

2. The method of claim 1, further comprising:
automatically transmitting a reservation request to a server to reserve the at least one recommended charging station for the one or more vehicles.

3. The method of claim 2, further comprising:
receiving a confirmation from the server that the reservation request is successful; and
automatically transmitting an update message to at least one other charging station of the one or more charging stations that the one or more vehicles will not be coming to the at least one other charging station.

4. The method of claim 1, wherein the list of one or more charging stations is determined by querying a geographic database based on one or more predicted ranges of the one or more vehicles.

5. The method of claim 1, further comprising:
determining a charging duration at each of the one or more charging stations for the one or more vehicles to achieve a charging level predicted for the one or more vehicles to reach one or more respective destinations,
wherein the respective probabilities are further based on the charging duration.

6. The method of claim 1, wherein the one or more preference values are computed based on a delay in reaching one or more destinations by the one or more vehicles caused by detouring to and charging at the one or more charging stations.

7. The method of claim 1, wherein the one or more preference values are computed based on a cost of charging at the one or more charging stations.

8. The method of claim 1, wherein the one or more preference values are computed based on a predicted charge time at the one or more charging stations.

9. The method of claim 1, wherein the one or more transmissions are anonymized to prevent determination of respective positions of the one or more vehicles.

10. The method of claim 1, wherein identification information of the one or more vehicles is anonymized as a hash of a vehicle identifier, a trip identifier, a charging station identifier, a random salt, or a combination thereof.

11. The method of claim 1, wherein an availability of the one or more charging stations is based on the one or more charging stations having one or more available charging slots at the one or more estimated times of arrival.

12. The method of claim 1, wherein the one or more transmissions are in a data format comprising a charging station identifier data field, an estimated time of arrival data field, and a preference value data field.

13. An apparatus comprising:
at least one processor; and
at least one memory including computer program code for one or more programs,
the at least one memory and the computer program code configured to, with the at least one processor, cause the apparatus to perform at least the following,
identify one or more charging stations that are within a range of a vehicle based on a battery level of the vehicle;
determine one or more estimated times of arrival for the vehicle to reach each of the one or more charging stations;
determine one or more preference values computed to indicate a preference of the vehicle to reach each of the one or more charging stations; and
send a transmission comprising a list of the one or more charging stations, the one or more estimated times of arrival, and the one or more preference values,
wherein the one or more charging stations, the one or more estimated times of arrival, and the one or more preference values are used to determine respective probabilities that each of the one or more charging stations will be available at the one or more estimated times of arrival.

14. The apparatus of claim 13, wherein the apparatus is further caused to:
receive at least one recommended charging station determined from among the one or more charging stations based on the transmission,
wherein the at least one recommended charging station is based on the respective probabilities.

15. The apparatus of claim 14, wherein the apparatus is further cause to:
automatically transmit a reservation request to a server to reserve the at least one recommended charging station for the vehicle.

16. The apparatus of claim 13, wherein the apparatus is further caused to:
determine an estimated charge for the vehicle to reach a destination from each of the one or more charging stations,
wherein the respective probabilities are determined further based on the estimated charge.

17. The apparatus of claim 1, wherein the apparatus is further caused to:
remove a charging station from the list of the one or more charging stations based on determining that the charging station is farther than a threshold distance from a destination of the vehicle.

18. A non-transitory computer-readable storage medium carrying one or more sequences of one or more instructions which, when executed by one or more processors, cause an apparatus to perform:
receiving one or more transmissions from one or more vehicles, wherein each of the one or more transmissions comprises a list of one or more charging stations, one or more estimated times of arrival for the one or more vehicles to reach each of the one or more charging stations, and one or more preference values computed to indicate a preference of the one or more vehicles to reach each of the one or more charging stations;
processing the list of the one or more charging stations, the one or more estimated times of arrival, and the one or more preference values to determine respective probabilities that each of the one or more charging stations will be available at the one or more estimated times of arrival;
determining at least one recommended charging station from among the one or more charging stations based on the respective probabilities; and
providing the at least one recommended charging station as an output.

19. The non-transitory computer-readable storage medium of claim 18, wherein the apparatus is caused to further perform:
automatically transmitting a reservation request to a server to reserve the at least one recommended charging station for the one or more vehicles.

20. The non-transitory computer-readable storage medium of claim 19, wherein the apparatus is caused to further perform:
receiving a confirmation from the server that the reservation request is successful; and
automatically transmitting an update message to at least one other charging station of the one or more charging stations that the one or more vehicles will not be coming to the at least one other charging station.
